(19) United States
(12) Patent Application Publication
(10) Pub. No.: US 2026/0221117 A1
(43) Pub. Date: Jul. 30, 2026

(54) PANEL SELF REFRESH DURING DISPLAY PROPERTY CHANGES

(71) Applicant: Intel Corporation, Santa Clara, CA (US)

(72) Inventors: Krishna Kishore Nidamanuri, Bangalore (IN); Susanta Bhattacharjee, Bangalore (IN); Bharatkumar Mahajan, Bangalore (IN); Perazhi Sameer Kalathil, Folsom, CA (US); Arvind Tomar, Folsom, CA (US)

(21) Appl. No.: 18/897,924

(22) Filed: Sep. 26, 2024

(51) Int. Cl. G09G 5/00

(52) U.S. Cl. CPC G09G 5/006; G09G 2330/021; G09G 2340/0435; G09G 2360/18

(57) ABSTRACT

An electronic device, including: a display panel configured to display image frame data received from a source device directly; a remote frame buffer configured to store the image frame data received from the source device; and a display panel controller configured to refresh the image frame data displayed on the display panel with the image frame data stored in the remote frame buffer when changing a display property.

### TECHNICAL FIELD

Aspects described herein generally relate to embedded display panels and, more particularly, to embedded display panels with panel self refresh during mode changes.

### BACKGROUND

Current embedded DisplayPort (eDP) panels exhibit undesirable screen flashing or momentary black screens during transitions that require a mode change. These transitions occur in various scenarios, such as switching between Standard Dynamic Range (SDR) and High Dynamic Range (HDR) modes, adjusting the screen refresh rate (which involves pixel clock timing changes), or swapping display controller pipelines during lid close/open events when external monitors are connected. Additionally, as future devices dynamically switch between SDR and HDR modes based on content type, this issue is expected to persist. The screen flashing or momentary black screens result in a poor user experience, disrupting the seamless operation of display systems.

One potential approach to mitigate this issue involves running the display controller pipeline continuously at a maximum clock speed and voltage. However, this solution significantly impacts power consumption and reduces battery life, particularly in mobile devices, where power efficiency is critical.

### BRIEF DESCRIPTION OF THE FIGURES

FIG. 1 illustrates a block diagram of an electronic device in accordance with aspects of the disclosure.

FIG. 2A illustrates a flow diagram that demonstrates an example of mode switching from Standard Dynamic Range (SDR) to High Dynamic Range (HDR) as a display property change in accordance with aspects of the disclosure.

FIG. 2B illustrates a pseudo-code example for SDR to HDR mode switching in accordance with aspects of the disclosure.

FIG. 3A illustrates a flow diagram that demonstrates an example of refresh rate as a display property change in accordance with aspects of the disclosure.

FIG. 3B illustrates a pseudo-code example for link or refresh rate change in accordance with aspects of the disclosure.

### DETAILED DESCRIPTION

The aspects of the present disclosure enable seamless transitions between display properties without screen flashing or momentary blackouts. Upon receiving a mode set request from an operating system to a graphics driver, a Panel Self refresh (PSR) function is utilized. This approach prevents screen flashing and ensures a seamless transition during mode changes, providing a smooth and uninterrupted user experience.

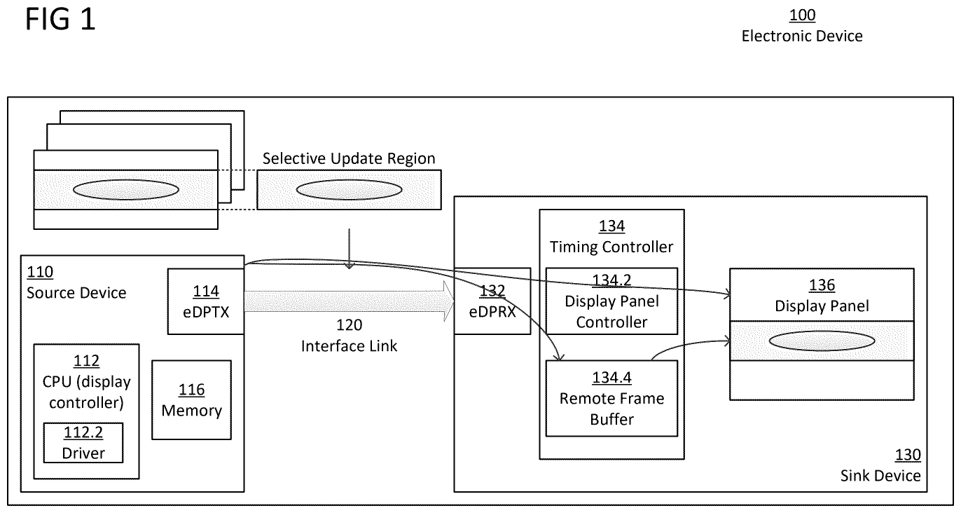

FIG. 1 illustrates a block diagram of an electronic device 100 in accordance with aspects of the disclosure.

The electronic device 100 comprises a source device 110, an interface link 120, and a sink device 130. The electronic device 100 may be, for example, a mobile personal computer, a laptop, a notebook, a smartphone, a tablet, or similar device.

The source device 110 is a graphics processing unit (GPU) or integrated graphics on a system motherboard and serves as the source of image frame data. The source device 110 comprises a central processing unit (CPU; display controller 112) and an embedded DisplayPort transmitter (eDPTX) 114, and a memory 116. The display controller 112 comprises a driver 112.2, which is a GPU software driver that controls the eDPTX 114.

The sink device 130 is an embedded display panel that is configured to receive image frame data from the source device 110 via the interface link 120. The sink device 130 comprises an embedded DisplayPort receiver (eDPRX) 132, a timing controller (TCON) 134, and a display panel 136.

The display panel 136 may be an embedded Display Port (eDP) panel, as is typically found in mobile personal computers.

The timing controller 134 comprises a display panel controller 134.2 and a remote frame buffer 134.4. The display panel controller 134.2 is configured to send the image frame data directly to the display panel 136, or alternatively and/or additionally, storing it in the remote frame buffer 134.4.

The interface link 120 connects the embedded DisplayPort transmitter (eDPTX) 114 of the source device 110 with the embedded DisplayPort receiver (eDPRX) 132 of the sink device. This interface link 120, which may be an embedded DisplayPort interface, is configured to transmit image frame data from the source device 110 to the sink device 130.

The remote frame buffer 134.4 is configured to store the image frame data received from the source device 110. Aspects of this disclosure are relevant to display panels equipped with such a remote frame buffer 134.4.

The display panel 136 is configured to display image frame data either directly from the source device 110 or from the remote frame buffer 134.4 when in a panel self refresh (PSR) active state. PSR may conserve power by transmitting only changed regions of the image frame data, referred to as “selective update regions,” from the source device 110 over interface link 120. Upon entering a PSR active state, the source device 110 prompts the sink device 130 to capture the active image frame data in the remote frame buffer 134.4, which is then used to continuously refresh the display panel 136.

In accordance with aspects of this disclosure, the display panel controller 134.2 refreshes the display panel 136 using image frame data stored in the remote frame buffer 134.4 rather than data directly from the source device 110 during a display property change (mode change).

In response to a request to change the display property, the display panel controller 134.2 enters a PSR active state, changes the display property, and then exits the PSR active state. During the PSR active state, the display panel controller 134.2 refreshes the display panel 136 using the image frame data stored in the remote frame buffer 134.4.

The change in display property may involve one or more characteristics, such as switching between Standard Dynamic Range (SDR) and High Dynamic Range (HDR), altering refresh rates, adjusting display panel link rates, modifying display controller pipelines, or scaling the display, among other changes.

Additionally, the display panel controller 134.2 may refresh the display panel 136 using data from the remote frame buffer 134.4 when the source device 110 resets the display controller pipeline or the interface link 120 that couples the source device 110 with the display panel controller 134.2 of the sink device 130, as an alternative to changing display properties.

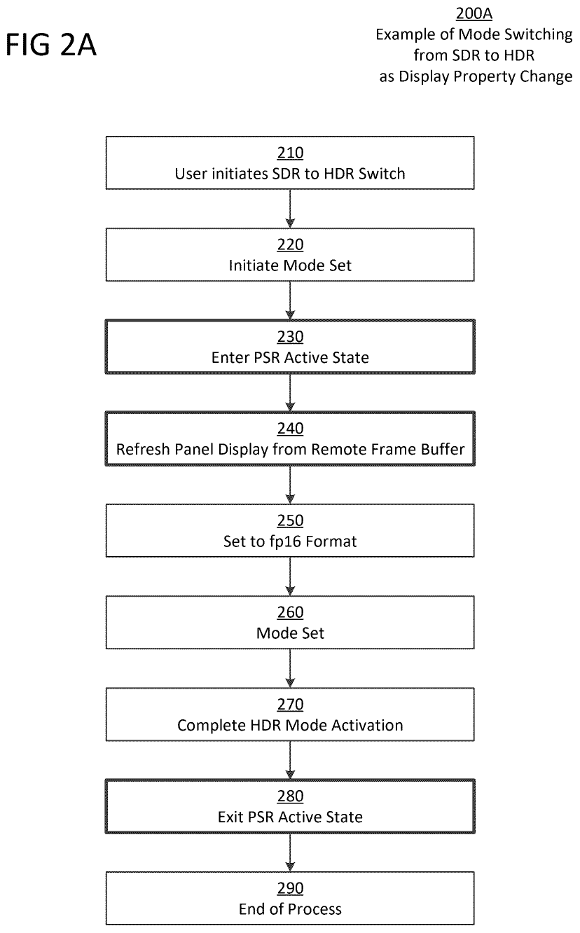

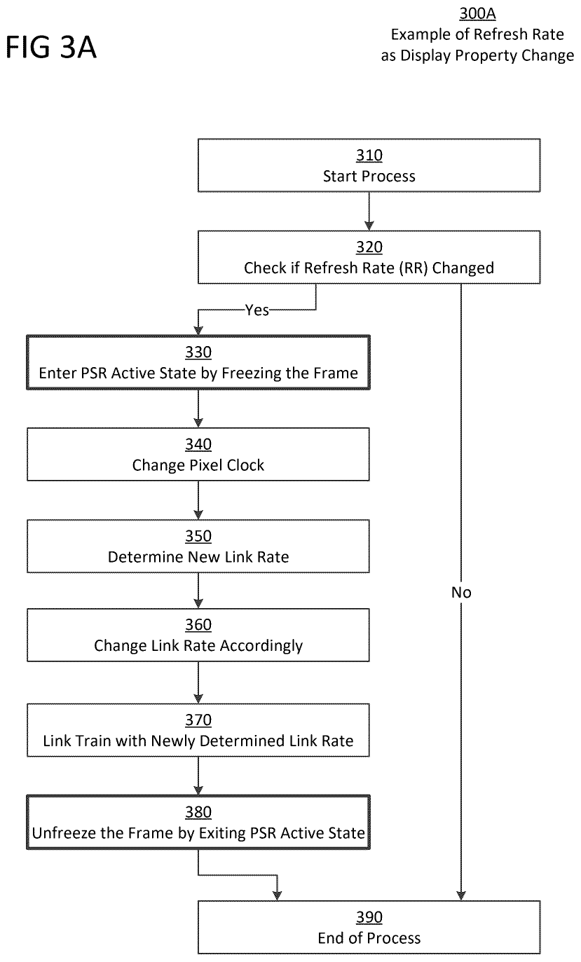

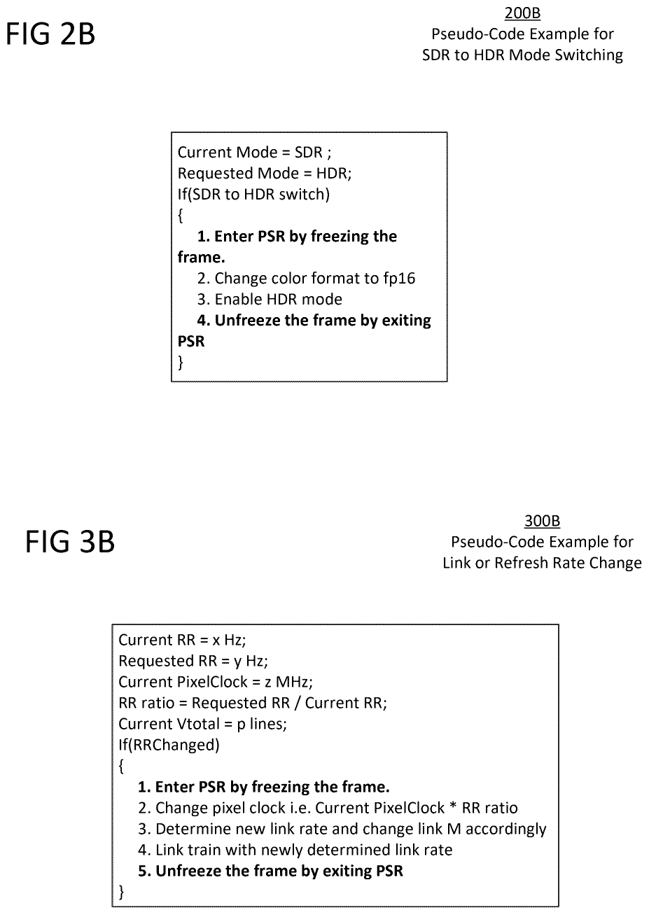

FIG. 2A illustrates a flow diagram 200A that demonstrates an example of mode switching from Standard Dynamic Range (SDR) to High Dynamic Range (HDR) as a display property change in accordance with aspects of the disclosure.

As an overview, when the source device 110 initiates a display property change, it enters a mode set, which typically causes screen blanking. To prevent this, the source device 110 freezes the display panel 136 and activates a PSR active state, which enables the display panel 136 to refresh from the remote frame buffer 134.4. During this process, the timing controller 134 refreshes the display panel 136 using image frame data stored in the remote frame buffer 134.4.

In this example, a user initiates a display property change from SDR to HDR (Step 210). In response, the source device 110 initiates a mode set to the driver 112.2 (Step 220). The source device 110 activates the PSR active state (Step 230) and then disables the display controller pipeline. While in the PSR active state, the display panel controller 134.2 refreshes the display panel 136 from the remote frame buffer 134.4 (Step 240). The display controller 112 inside the source device 110 then modifies the display property from SDR to HDR with a pixel format of fp16 (Step 250). The mode set process is completed (Step 260), followed by the completion of HDR activation (Step 270). After that, the display controller 112 inside the source device 110 triggers the deactivation of the PSR active state. Until then, the display panel 136 continues to refresh from the remote frame buffer 134.4. Once the display controller 112 inside the source device 110 triggers the deactivation of the PSR active state, display panel controller 134.2 exits the PSR active state and unfreezes the display panel 136 (Step 280). The display controller 112 inside the source device 110 marks it as the end of the process (Step 290). Once the PSR active state is exited, the display panel controller 134.2 resumes updating the display panel 136 with display frame data received directly from the source device 110. The driver 112.2, running in the display controller 112 of the source device, oversees and controls the steps outlined in FIG. 2A.

In conventional systems, disabling the display controller pipeline during a display property change typically results in a temporary blackout on the display panel 136. However, by activating the PSR state, the blackout is avoided, ensuring a seamless transition in display panel properties.

FIG. 2B illustrates a pseudo-code example 200B for SDR to HDR mode switching in accordance with aspects of the disclosure. This pseudo-code example is provided merely as an illustrative example and is believed to be self-explanatory.

FIG. 3A illustrates a flow diagram 300A that demonstrates an example of refresh rate as a display property change in accordance with aspects of the disclosure.

In this example, the process begins (Step 310) with the source device 110 determining whether a change in refresh rate is required (Step 320). If no change is necessary, the process concludes (Step 390). If a refresh rate change is required, the source device 110 activates the PSR active state (Step 330) and then disables the display controller pipeline. While in the PSR active state, the source device 110 adjusts the pixel clock (Step 340), determines the new link rate (Step 350), and modifies the link rate accordingly (Step 360). The new link rate is then applied (Step 370). After completing the link rate adjustment, the display panel controller 134.2 exits the PSR active state and unfreezes the display panel 136 (Step 380), signaling the end of the display property change process (Step 390). The driver 112.2, running on the display controller 112 of the source device, manages and controls the steps illustrated in FIG. 3A.

FIG. 3B illustrates a pseudo-code example 300B for refresh rate change in accordance with aspects of the disclosure. This pseudo-code example is provided merely as an illustrative example and is believed to be self-explanatory.

The aspects of this disclosure provide significant benefits in various scenarios.

Dynamically Enabling HDR Mode: In existing solutions, HDR mode is manually enabled by the end user and remains active even when the content is in SDR, which leads to increased power consumption. With the aspects of this disclosure, there is a seamless transition between HDR and SDR modes, resulting in optimized power usage without compromising the user experience.

Dynamically Changing the eDP Link Rate and Refresh Rate: The aspects of this disclosure allow for seamless link rate changes for eDP panels, eliminating the need for panels to operate continuously at the maximum link rate programmed during the initial link training. Additionally, it enables seamless refresh rate adjustments, which involve changes to the pixel clock. By optimizing the panel pixel clock and the SoC display core clock in sync with the link rate, the system achieves significant power savings for both the panel and the SoC.

Dynamically Swapping the Display Pipe: High refresh rates, such as 300 Hz, require a pixel clock higher than 1200 MHz, which cannot be handled by a single display pipe. The pipe joiner feature is enabled to support such high refresh rates. Traditionally, enabling the pipe joiner sometimes needs display controller pipe swapping which results in a mode set and screen flashing. However, the aspects of this disclosure prevent screen flashing, allowing for a seamless transition during display pipe swaps.

Dynamic Display Scaling: In scenarios where display scaling changes, such as when switching to super-resolution, the display typically needs to be enabled or disabled, which causes a brief display blackout. With the aspects of this disclosure, the display blackout is avoided, ensuring a seamless transition during scaling changes.

The aspects of the present disclosure enable seamless transitions between display properties without screen flashing or momentary blackouts. This ensures an optimal visual experience for the end user. Additionally, the aspects of the disclosure achieve these transitions while maintaining power efficiency, resulting in significant power savings, particularly beneficial for mobile devices.

The disclosed aspects may be implemented, in some cases, in hardware, firmware, software, or any combination thereof. The disclosed aspects may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

The memory 116 may be embodied as any type of volatile or non-volatile memory or data storage capable of performing the functions described herein. In operation, the memory 116 may store various data and software used during the operation of the electronic device 100, such as operating systems, applications, programs, libraries, and drivers.

The display panel 136 may be embodied as any type of display on which information may be displayed to a user of the electronic device 100, such as a touchscreen display, a liquid crystal display (LCD), a thin film transistor LCD (TFT-LCD), a light emitting diode (LED) display, an organic light emitting diode (OLED) display, a cathode ray tube (CRT) display, a plasma display, an image projector (e.g., 2D or 3D), a laser projector, a heads-up display, and/or other display technology.

The techniques of this disclosure may also be described in the following examples.

### Example 1

An electronic device, comprising: a display panel configured to display image frame data received from a source device directly; a remote frame buffer configured to store the image frame data received from the source device; and a display panel controller configured to refresh the image frame data displayed on the display panel with the image frame data stored in the remote frame buffer when changing a display property.

### Example 2

The electronic device of example 1, wherein, in response to a request to change the display property, the display panel controller is further configured to: enter a panel self refresh (PSR) active state; change the display property; and exit the PSR active state.

### Example 3

The electronic device of any of examples 1-2, wherein the display panel controller is configured to refresh the image frame data displayed on the display panel using the image frame data stored in the remote frame buffer during the PSR active state.

### Example 4

The electronic device of any of examples 1-3, wherein the change in the display property is between Standard Dynamic Range (SDR) and High Dynamic Range (HDR) modes.

### Example 5

The electronic device of any of examples 1-4, wherein the change in the display property is between different display panel refresh rates.

### Example 6

The electronic device of any of examples 1-5, wherein the change in the display property is between different display panel link rates.

### Example 7

The electronic device of any of examples 1-6, wherein the change in the display property is between different display controller pipelines.

### Example 8

The electronic device of any of examples 1-7, wherein the change in the display property is between different display panel

### Scalings.

### Example 9

The electronic device of any of examples 1-8, wherein the display panel is an embedded Display panelPort (eDP) panel.

### Example 10

An electronic device, comprising: a display panel configured to display image frame data received from a source device directly; a remote frame buffer configured to store the image frame data received from the source device; and a display panel controller configured to refresh the image frame data displayed on the display panel with the image frame data stored in the remote frame buffer when the source device resets a display controller pipeline or resets an interface coupling the source device and the display panel controller.

### Example 11

The electronic device of example 10, wherein, in response to a request to the source device resetting the display controller pipeline or resetting an interface coupling the source device and the display panel controller, the display panel controller is further configured to: enter a panel self refresh (PSR) active state; reset a display controller pipeline or reset an interface coupling the source device and the display panel controller; and exit the PSR active state.

### Example 12

A component of an electronic device, comprising: processing circuitry; and a non-transitory computer-readable storage medium including instructions that, when executed by the processing circuitry, cause the processing circuitry to: display, on a display panel, image frame data received from a source device directly; store the image frame data received from the source device in a remote frame buffer; change a display property; and refresh the image frame data displayed on the display panel with the image frame data stored in the remote frame buffer when changing a display property.

### Example 13

The component of example 12, wherein, in response to a request to change the display property, the instructions that further cause the processing circuitry to: enter a panel self refresh (PSR) active state; change the display property; and exit the PSR active state.

### Example 14

The component of any of examples 12-13, wherein the instructions that further cause the processing circuitry to: refresh the image frame data displayed on the display panel using the image frame data stored in the remote frame buffer during the PSR active state.

### Example 15

The component of any of examples 12-14, wherein the change in the display property is between Standard Dynamic Range (SDR) and High Dynamic Range (HDR) modes.

### Example 16

The component of any of examples 12-15, wherein the change in the display property is between different display panel refresh rates.

### Example 17

The component of any of examples 12-16, wherein the change in the display property is between different display panel link rates.

### Example 18

The component of any of examples 12-17, wherein the change in the display property is between different display controller pipelines.

### Example 19

The component of any of examples 12-18, wherein the change in the display property is between different display panel scalings.

### Example 20

The component of any of examples 12-19, wherein the display panel is an embedded Display panelPort (eDP) panel.

### Example 21

An electronic device, comprising: a display panel means for displaying image frame data received from a source device directly; a remote frame buffer configured to store the image frame data received from the source device; and a display panel controller means for refreshing the image frame data displayed on the display panel means with the image frame data stored in the remote frame buffer when changing a display property.

### Example 22

The electronic device of example 21, wherein, in response to a request to change the display property, the display panel controller means for: entering a panel self refresh (PSR) active state; changing the display property; and exiting the PSR active state.

### Example 23

The electronic device of any of examples 21-22, wherein the display panel controller means for refreshing the image frame data displayed on the display panel means using the image frame data stored in the remote frame buffer during the PSR active state.

### Example 24

The electronic device of any of examples 21-23, wherein the change in the display property is between Standard Dynamic Range (SDR) and High Dynamic Range (HDR) modes.

### Example 25

The electronic device of any of examples 21-24, wherein the change in the display property is between different display panel refresh rates.

### Example 26

The electronic device of any of examples 21-25, wherein the change in the display property is between different display panel link rates.

### Example 27

The electronic device of any of examples 21-26, wherein the change in the display property is between different display controller pipelines.

### Example 28

The electronic device of any of examples 21-27, wherein the change in the display property is between different display panel scalings.

### Example 29

The electronic device of any of examples 21-28, wherein the display panel means is an embedded Display panelPort (eDP) panel.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. An electronic device, comprising:
a display panel configured to display image frame data received from a source device directly;
a remote frame buffer configured to store the image frame data received from the source device; and
a display panel controller configured to refresh the image frame data displayed on the display panel with the image frame data stored in the remote frame buffer when changing a display property.

2. The electronic device of claim 1, wherein, in response to a request to change the display property, the display panel controller is further configured to:
enter a panel self refresh (PSR) active state;
change the display property; and
exit the PSR active state.

3. The electronic device of claim 2, wherein the display panel controller is configured to refresh the image frame data displayed on the display panel using the image frame data stored in the remote frame buffer during the PSR active state.

4. The electronic device of claim 1, wherein the change in the display property is between Standard Dynamic Range (SDR) and High Dynamic Range (HDR) modes.

5. The electronic device of claim 1, wherein the change in the display property is between different display panel refresh rates.

6. The electronic device of claim 1, wherein the change in the display property is between different display panel link rates.

7. The electronic device of claim 1, wherein the change in the display property is between different display controller pipelines.

8. The electronic device of claim 1, wherein the change in the display property is between different display panel scalings.

9. The electronic device of claim 1, wherein the display panel is an embedded Display Port (eDP) panel.

10. An electronic device, comprising:
a display panel configured to display image frame data received from a source device directly;
a remote frame buffer configured to store the image frame data received from the source device; and
a display panel controller configured to refresh the image frame data displayed on the display panel with the image frame data stored in the remote frame buffer when the source device resets a display controller pipeline or resets an interface coupling the source device and the display panel controller.

11. The electronic device of claim 10, wherein, in response to a request to the source device resetting the display controller pipeline or resetting an interface coupling the source device and the display panel controller, the display panel controller is further configured to:
enter a panel self refresh (PSR) active state;
reset a display controller pipeline or reset an interface coupling the source device and the display panel controller; and
exit the PSR active state.

12. A component of an electronic device, comprising:
processing circuitry; and
a non-transitory computer-readable storage medium including instructions that, when executed by the processing circuitry, cause the processing circuitry to:
display, on a display panel, image frame data received from a source device directly;
store the image frame data received from the source device in a remote frame buffer;
change a display property; and
refresh the image frame data displayed on the display panel with the image frame data stored in the remote frame buffer when changing a display property.

13. The component of claim 12, wherein, in response to a request to change the display property, the instructions that further cause the processing circuitry to:
enter a panel self refresh (PSR) active state;
change the display property; and
exit the PSR active state.

14. The component of claim 13, wherein the instructions that further cause the processing circuitry to:
refresh the image frame data displayed on the display panel using the image frame data stored in the remote frame buffer during the PSR active state.

15. The component of claim 12, wherein the change in the display property is between Standard Dynamic Range (SDR) and High Dynamic Range (HDR) modes.

16. The component of claim 12, wherein the change in the display property is between different display panel refresh rates.

17. The component of claim 12, wherein the change in the display property is between different display panel link rates.

18. The component of claim 12, wherein the change in the display property is between different display controller pipelines.

19. The component of claim 12, wherein the change in the display property is between different display panel scalings.

20. The component of claim 12, wherein the display panel is an embedded Display Port (eDP) panel.
